(19) United States
(12) Patent Application Publication
(10) Pub. No.: US 2011/0007280 A1
(43) Pub. Date: Jan. 13, 2011

(54) LIGHTING DEVICE FOR A ROUTE GUIDANCE SYSTEM

(76) Inventor: Kieran Patterson, Lurgan (GB)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 12/921,870

(22) PCT Filed: Mar. 9, 2010
(86) PCT No.: PCT/EP09/01669

§ 371 Date: Sep. 10, 2010

(30) Foreign Application Priority Data
Mar. 11, 2008 (GB) 0804472.9

(51) Int. Cl. G03B 21/00; F21V 11/00; G08B 17/00

(52) U.S. Cl. 353/12; 362/235; 353/11; 362/509; 340/584

(57) ABSTRACT

A lighting device (10) for a route guidance system comprises a body (12) adapted to be mounted to a surface; at least one light source (18) housed within the body; a corresponding at least one outlet (14, 16) in the body from which light may be emitted; and focusing means (20) operable to focus the light into a beam projecting from the outlet. In one embodiment the device comprises a pair of outlets (14, 16) in the body, the focusing means being operable to focus light from the at least one light source into a pair of beams, one beam projecting from each outlet. In a second embodiment, the focusing means of the device is operable to focus the beam onto an adjacent surface. The device may be adapted to project static and/or moving images onto said adjacent surface.

The present invention is concerned with a lighting device for a route guidance system for guiding occupants of an enclosed space, such as a building, and in particular a route guidance system which is operable to provide guidance in the event of an emergency, such as a fire and the associated smoke, in particular by providing a focused beam of light projecting from a device forming part of the system of the invention.

In recent years, natural disasters and terrorist threats, coupled with a growing awareness of public safety, has highlighted the need for action to be taken in addressing the issue of mass evacuation of people from all enclosed spaces. Examples of this are only too frequent, in particular in light of the 9/11 tragedy, the Austrian fire tunnel disaster, the Mont Blanc road tunnel disaster, all of which have heightened the concerns of all countries with respect to measures to be taken in limiting the damage caused, and more importantly in saving lives.

Statistics show an ever growing demand on public transport, which is apparent when we look at the escalating number of people using the underground networks of various countries. For example, there are 3.5 million people travelling daily on the London Underground alone, 2 million people using the 722 miles of the New York subway and 20 almost 6 million people commuting via the Paris Metro. With such vast numbers of people contained in a limited area of space, it is clearly recognised that while prevention is always the best outcome, minimising the potential destruction and devastation is also as important.

In August 2003, New York was placed in the ever more occurring situation of a blackout, when the national grid failed. Tens of thousands of people fled into the streets after a power outrage turned out the lights and shut down air conditioning across the city. The fire department stated that it was nearly overwhelmed by phone calls reporting people trapped in elevators and subways. It took almost two and a half hours for people to evacuate from the subway to safety.

As a direct result of the most recent tunnel disasters in Europe, a new European directive has been issued on road tunnel safety. This sets out all aspects of tunnel safety which are required in the future. A time scale has been set by which all EU countries must comply and tunnels must be refurbished to meet the new requirements, which include recommendations and emergency lighting.

The present invention has therefore been developed with a view to mitigating the above mentioned problems.

The present invention therefore provides a lighting device for a route guidance system, the lighting device comprising a body adapted to be mounted to a surface; at least one light source housed within the body; a corresponding at least one outlet in the body from which light may be emitted; and focusing means operable to focus the light into a beam projecting from the outlet.

Preferably, the light source comprises at least one LED.

Alternatively, the light source comprises a laser cluster.

Preferably, the light source comprises an array of LED's.

In one embodiment, the device comprises a pair of outlets in the body, the focusing means being operable to focus light from the at least one light source into a pair of beams, one beam projecting from each outlet.

Preferably, the pair of outlets are arranged such that the pair of beams are directed in substantially opposite directions to one another.

Preferably, the device is actuable in response to a signal from a sensor, whether the sensor is housed within the device or remotely therefrom.

The device may comprise a sensor operable to generate a signal in response to an external event, the signal actuating the at least one light source.

Preferably, the sensor is a heat sensor and/or a smoke sensor and/or an auditory sensor.

Alternatively, the sensor is a light sensor, the light sensor operable to generate a signal on detection of a reduced light level.

Preferably, the device comprises a display located on the body.

In a second embodiment, the focusing means of the device is operable to focus the beam onto an adjacent surface. The device may be adapted to project static and/or moving images onto said adjacent surface.

Preferably, the device is arranged to project information onto, in use, said adjacent surface.

The device may be adapted to project directional information, such as a directional arrow, onto said adjacent surface and/or to project advertising images onto said surface.

Preferably, the device comprises means for projecting information, in use, within the beam(s) of light projecting from the outlet(s).

Preferably, the projecting means is adapted to project a directional arrow within the beam(s).

Preferably, the device comprises an independent power supply.

Preferably, the device is arranged to communicate with a remote device or one or more other similar or identical lighting devices.

Preferable, the device is arranged to receive and send information to the remote device or one or more other lighting devices

Preferably, the device is arranged to project still images.

Preferably, the device is arranged to project various images.

Preferably, the device is arranged to project an image stream.

Preferably, the device is arranged to detect at least one sensor.

Preferably, the device comprises a motion and location detector and is arranged to communicate movement and location information to a central controller.

Preferably, the device comprises an auditory emitter operable to emit an auditory signal.

Preferably, the device is adapted to be integrated into an existing alarm system.

Preferably, the device comprises a counter operable to count the number of people passing the device.

According to a further aspect of the present invention there is provided a route guidance system comprising a plurality of lighting devices in accordance with the first aspect of the present invention.

Preferably, the system comprises a plurality of the devices arranged, in use, in series such that the facing beams of adjacent devices converge.

The device or system may be used in thoroughfares, underground passageways or buildings. In addition the device or system may be used in vehicles such as aircraft, trains and buses.

A second aspect of the invention provides a vehicle installation, for example a seat, having a . route guidance system embodying the second aspect of the invention mounted thereon.

The present invention will now be described with reference to the accompanying drawings, in which;

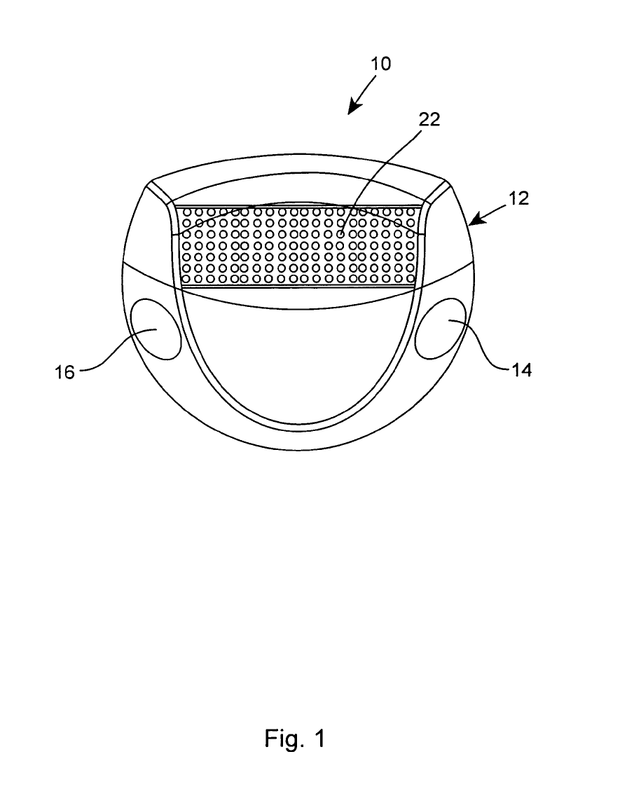

FIG. 1 illustrates a front elevation of a first embodiment of a lighting device forming part of a route guidance system according to the present invention;

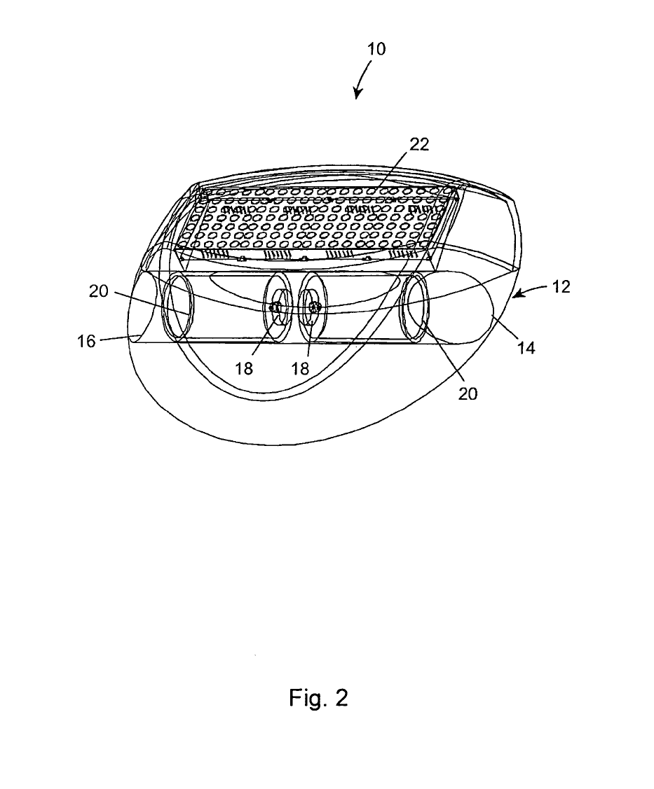

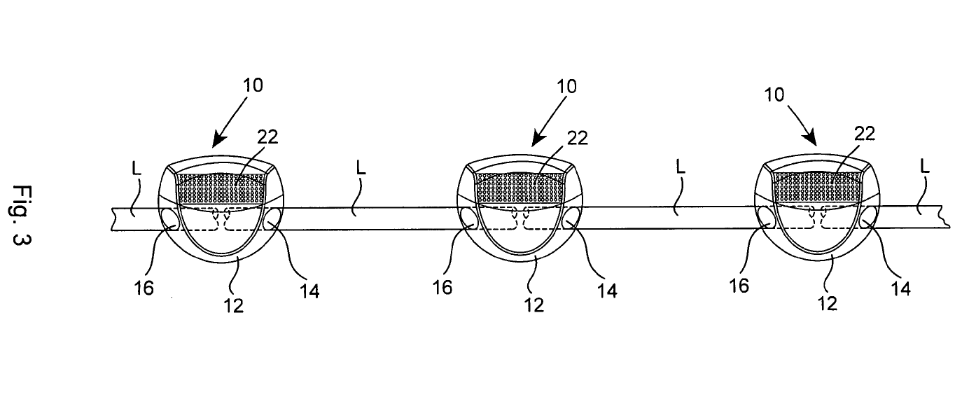

FIG. 2 illustrates an internal perspective view of the device illustrated in FIG. 1;

FIG. 3 illustrates a perspective view of a linear array of the devices illustrated in FIGS. 1 and 2, from which it can be seen that light beams projecting from each device converge; and

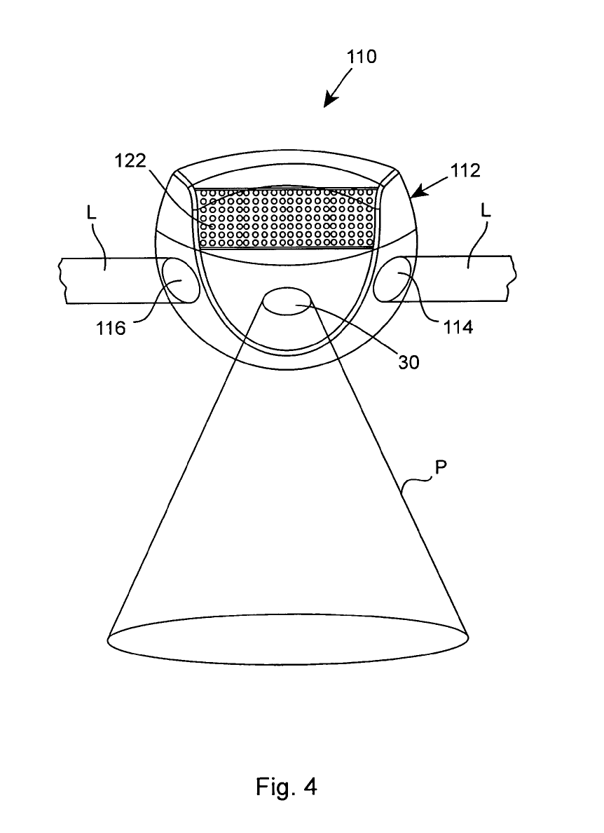

FIG. 4 illustrates a front elevation of a second embodiment of a lighting device forming part of the emergency lighting system of the present invention;.

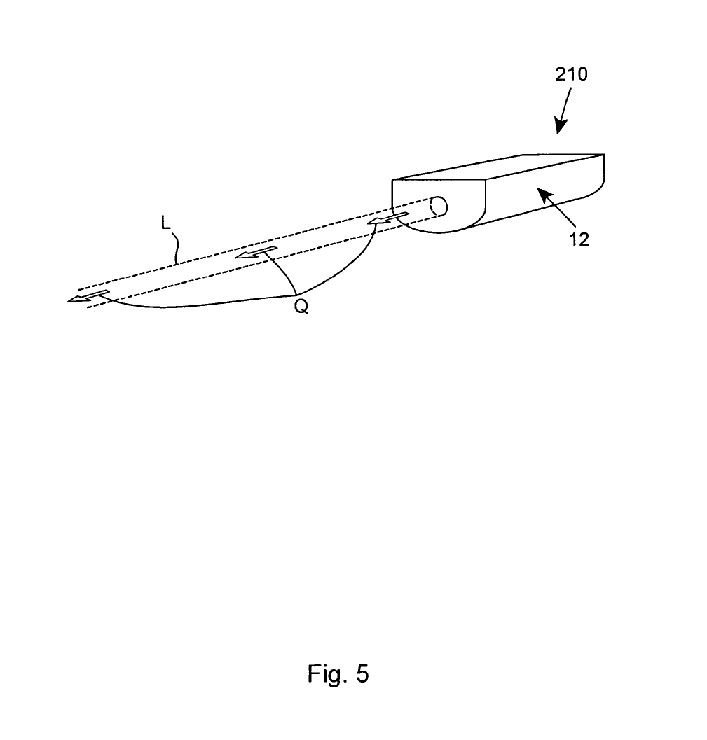

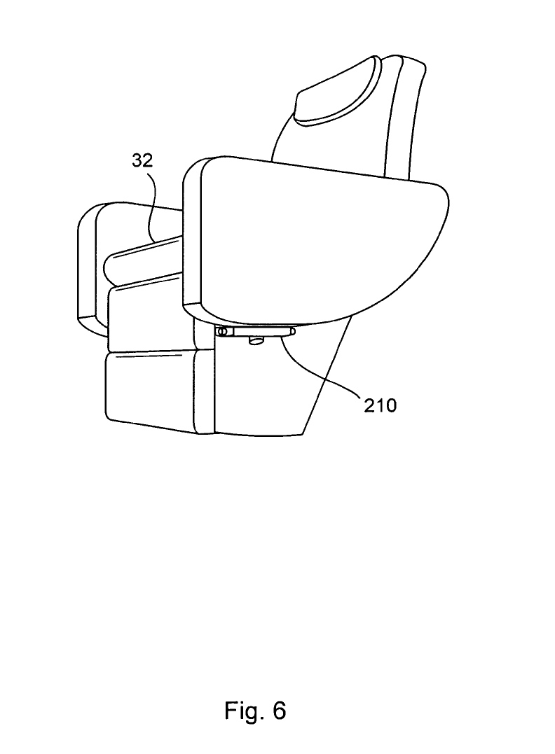

FIG. 5 illustrates a perspective view of a third embodiment of a lighting device;

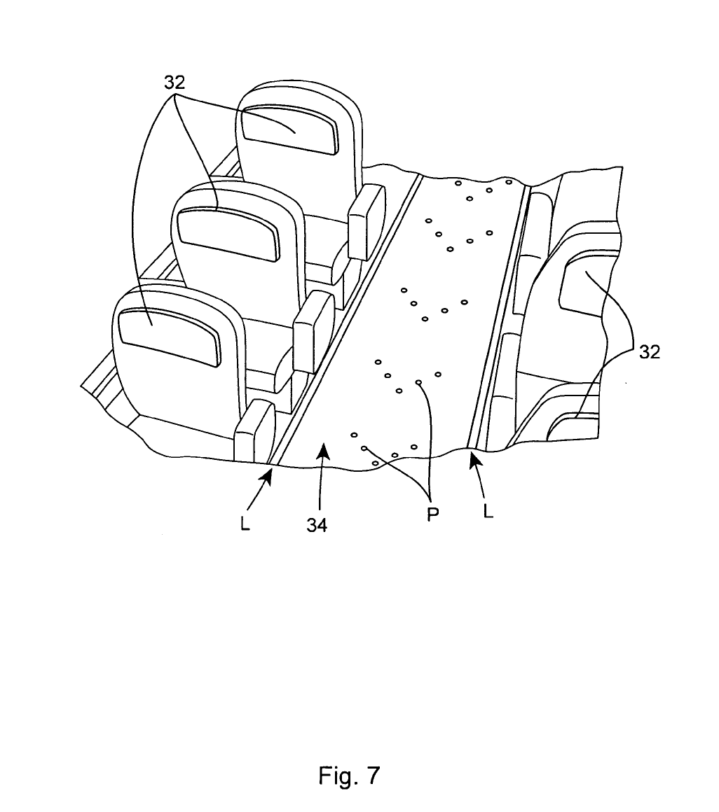

FIG. 6 illustrates a preferred mode of use of the lighting devices, wherein the lighting device is installed in a vehicle;

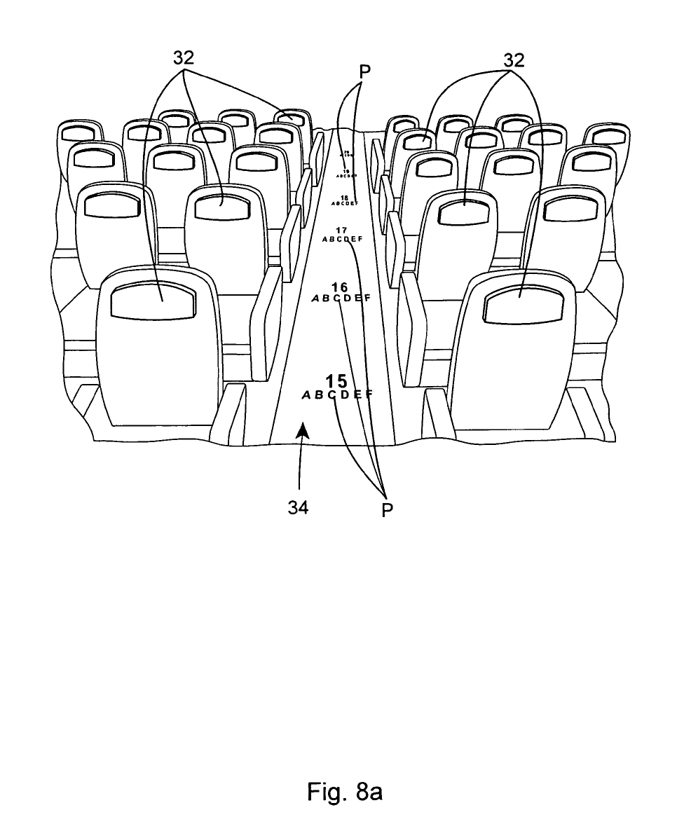

FIG. 7 illustrates a perspective view of part of a vehicle, in particular the seats and aisle of an aircraft, and shows the lighting system in full emergency mode whereby two beams of light are projected along the aisle and emergency exit information is projected onto the aisle floor;

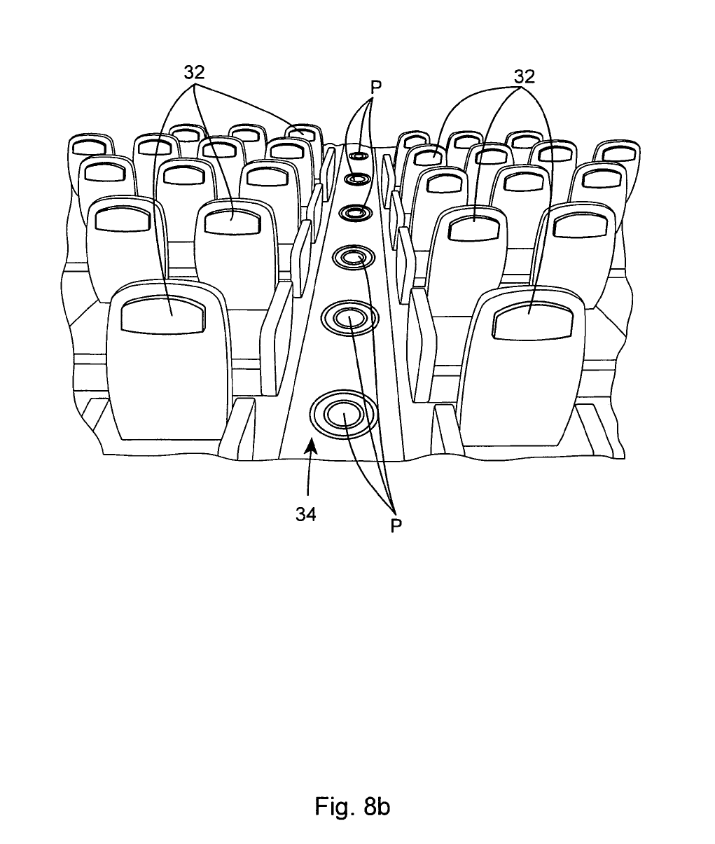

FIG. 8a illustrates a perspective view of part of a vehicle, and shows the lighting system in standby mode whereby seat information is projected onto the aisle floor; and

FIG. 8b illustrates a perspective view of part of the vehicle of FIG. 8a, showing the lighting system in standby mode whereby advertising information is projected onto the aisle floor.

Referring now to FIGS. 1 and 2 of the accompanying drawings, there is illustrated a first embodiment of a lighting device, generally indicated as 10, forming part of a route guidance or emergency lighting system of the present invention. The device 10 comprises a body 12 having a first outlet 14 and a second outlet 16 therein, which in the embodiment illustrated are directly opposed to one another, the device 10 being adapted, as will be described hereinafter in detail, to project a focused beam L of light from each of the outlets 14, 16. In this way, the beams L of light, which will remain visible even in heavy smoke, can guide evacuating people in a particular direction. The device 10 is adapted, by conventional means, to be mounted to a surface (not shown) such as a wall or the like, and arranged such that in use, the beams L of light point towards an emergency exit or the like.

Referring to FIG. 3, the device 10 is primarily but not essentially intended to be employed in a linear array of the devices 10, such that the facing light beams L of adjacent devices 10 meet, preferably coaxially, such as to generate a continuous beam L between each set of adjacent devices 10. In this way it will be appreciated that the system formed from the linear array of devices 10 will, when activated, effectively generate a “guide rail” of light along a wall or the like, which can be positioned to guide evacuating people to an emergency exit or the like.

The device 10 is preferably mounted such that the “guide rail” of light produced is positioned at a height of approximately 25 cm to 30 cm above floor level.

In the embodiment illustrated, each light beam L is generated by an LED array 18 which focuses light through a respective lens 20 mounted adjacent the first outlet 14 and the second outlet 16. The lenses 20 serve to focus the light emitted from each LED array 18 into a tightly focused beam L which will therefore maintain its integrity over a significant distance. Although each LED array 18 could be replaced with an alternative light source (not shown), the light generated from LED's is capable of penetrating thick smoke, and thus provides a technical advantage over equivalent light sources. However, it is appreciated that the LED array and lens arrangement may be replaced by a laser cluster.

It will also be appreciated that the device 10 could be provided with a single outlet and associated LED array 18 and lens 20, in order to project a single light beam L therefrom. Similarly it will be appreciated that the device 10 could be adapted to project more than two light beams L therefrom. However the embodiment of the device 10 illustrated is the most preferred arrangement, as it is suitable for use in thoroughfares or underground passageways or the like, in order to clearly indicate the direction a person evacuating said space should be travelling.

The device 10 is preferably provided with one or more sensors (not shown), for example a heat sensor (not shown), a smoke sensor (not shown) and/or an auditory sensor (not shown). Alternatively, the sensor is a light sensor that generates a signal if the surrounding light level drops, for example in a smoke filled environment. In this way the device 10 is capable of being actuated if heat and/or smoke and/or an audible alarm or the like is detected, ensuring that the device 10 is independent of any other emergency systems (not shown) which may be present in any given location. In addition, although the device 10 may be adapted to be mains powered, it is preferable that the device 10 is provided with an independent power supply (not shown), for example a battery such as a lithium ion battery (not shown) in order to ensure that the device 10 is capable of operating in the event of a power failure or the like. Obviously the battery may be chosen to provide a desired operating time in the event of such a power failure.

The device 10 may also be linked into an existing emergency alarm system (not shown), for example a fire alarm system, in order to allow the device 10 to be actuated even when the device 10 is located at such a distance from any fire and/or smoke that the device 10 would not otherwise be triggered for some time. It is also preferred, when deploying a plurality of the devices 10, that all of the devices 10 are connected to a central controller (not shown) which may be programmed with the position of each device 10, such that the controller (not shown) may be utilised to co-ordinate the operation of the array of devices 10, in order to selectively activate and/or de-activate devices 10 in the array. The system can therefore be operated to direct evacuating people away from areas of danger, for example the source of the fire, and/or towards particular exits, depending on prevailing conditions such as expected numbers of people at a particular exit, which might otherwise result in an overloading of one or more emergency exits. To this end, each device 10 is preferably provided with a counter (not shown), of conventional form, which is operable to detect and count the number of people passing any one of the devices 10. In this way the controller (not shown) can keep track of the numbers of people moving in given directions and towards given exits, and thereby co-ordinate the actuation of the devices 10 in order to provide alternative exit routes as required.

The device 10 may also be provided with an auditory emitter in the form of a speaker (not shown) or the like, which may be activated depending on prevailing conditions, for example the auditory emitter may only be activated if a fire or heavy smoke is located in proximity to the respective device 10, thereby alerting an evacuating person to said conditions. The device 10 may also be adapted to generate a flashing light beam L from one or both of the outlets 16, 18, in order to indicate a given condition in the vicinity of the device 10, again for example the proximity of a fire or heavy smoke, or a blocked or inaccessible exit. This functionality may be achieved using conventional electronics, preferably integrated onto a printed circuit board or the like within the body 12, and no further technical explanation is considered necessary. Thus the device 10, and in particular the body 12, is formed from a fire proof material of conventional form.

The device 10 is also preferably provided with a display 22, which in the embodiment illustrated, is mounted on the body 12 at a position which is clearly visible. The display 22 may be of any conventional form, for example an LCD or an LED display, and during an emergency may be used to provide helpful information such as the distance and/or direction to the closest or safest emergency exit to use. When the device 10 is in standby mode, the display 22 may also be used for this function, or may be used for advertising purposes or the like.

In the preferred embodiment, the display 22 is arranged to display information, for example, a still image or a media stream, received from a remote device (not shown).

Referring now to FIG. 4, there is illustrated a second embodiment of a device, generally indicated as 110, which forms part of the route guidance system embodying the present invention. In the second embodiment like components have been accorded like reference numerals, and unless otherwise stated, perform a like function.

Thus the device 110 again comprises a body 112 having a first outlet 114 and a second outlet 116 therein. Located internally of the device 10 is a pair of LED arrays (not shown) and associated lenses (not shown) which are operable to project a beam L of light from each of the outlet 114, 116. The device 110 also includes a display 122 thereon. However, unlike the device of the first embodiment, the device 110 incorporates a projector 30, which in the embodiment illustrated is located towards the underside of the body 112, which projector 30 is of conventional form. In the preferred embodiment, the projector is a Holographic Laser Projector, such as that produced by Light Blue Optics, www.lightblueoptics.com. The projector 30 is adapted, whether in standby mode or in full emergency mode, to project information as a projection P onto a surface adjacent the device 110, in particular the ground directly adjacent the device 110. In addition, the device 110 is preferably adapted to project the information illustrated on the display 122 through the projector 30. In this way directional information or other helpful information will be visible to an evacuating person as they pass by the device 110, without requiring the person to be in close proximity to the device 110 in order to read the information provided thereby. Again during standby mode, the projector 30 may project any desired information, in particular advertising information or the like. However, it will be appreciated that the information being projected by the projector may differ from that presented on the display. For example, the projector may display information, such as a still image or a media stream, received from a separate remote device (not shown).

Referring now to FIG. 5, there is illustrated a third embodiment of a lighting device, generally indicated as 210, forming part of a route guidance system embodying the present invention. In the third embodiment like components have been accorded like reference numerals, and unless otherwise stated, perform a like function. In FIG. 5 the device 210 comprises a body 212. The device 210 includes means for projecting a focused beam of light L which may be substantially similar to the corresponding means provided in the devices 10, 110. FIG. 5 only shows a single beam L, although the device 210 may include means for projecting more than one beam L. For example, in the preferred embodiment, the device 210 is configured to project two focused beams from the body 212, advantageously in substantially opposite directions.

In the preferred embodiment, the device 210 includes means for creating an indicator such as a sign, word or arrow in the each beam L. This is achieved by means of a pulsing system provided in the device. In particular, it is preferred that the device 210 is arranged to project directional information such a directional arrow or plurality of directional arrows within the beam L of light. The directional information is, in use, visible to an evacuating person as they pass by the device 210, the directional information directing the evacuating people towards an exit or the like. In a preferred embodiment, the directional arrows will flash or pulsate within the beam L of light and/or move in the indicated direction along the beam L of light towards the emergency exit or the like. In this embodiment, a central controller (not shown) is programmed with the position of each device 10, such that the controller (not shown) may be utilised to co-ordinate activation and deactivation of the pulsing of the beams of light to thereby achieve the visual effect of the directional arrows moving towards the exit. The device 210 has a projector 30 which is arranged to project images downwardly in use.

Referring now to FIG. 6, there is illustrated a preferred mode of use of the lighting device, wherein the lighting device may take the form of the first, second or third embodiment of the device (10, 110, or 210) although it is shown as the device 210. In FIG. 6, the lighting device 210 forms part of the emergency light system within vehicles such as an aircraft, train or bus. The device 210 is adapted, by conventional means, to be mounted to a seat 32 (or other installation) nearest an aisle 34 (illustrated in FIGS. 7, 8a and 8b) of the vehicle. The device 210 is conveniently mounted, in use, on the underside of the seat, or other installation, or part thereof, e.g. the underside of an arm or arm rest. The device 210 is arranged such that, in use, the beam(s) L of light project(s) along the aisle 34 (substantially horizontally) towards an emergency exit or the like. It will be appreciated that the device may be placed in alternative positions such that the beam L of light still projects along the aisle 34 of the vehicle.

Referring to FIG. 7 a plurality of devices may be employed in a linear array at corresponding positions on respective seats 32 along the aisle 34 such that the facing light beams L of adjacent devices meet, preferably coaxially, such as to generate a continuous beam L of light between each set of adjacent devices. In this way the devices when activated, effectively generate a “guide rail” of light along the aisle. It will be appreciated that a plurality of devices may be employed in a linear array along both sides of the aisle 34 to produce two “guide rails” of light either side of the aisle 34.

Referring to FIGS. 7, 8a and 8b wherein the device may take the form of the second or third embodiments of the invention, the device is adapted, by conventional means, to be mounted within the vehicle such that the projector 30 may, in use, project information onto the floor of the aisle 34. Referring specifically to FIG. 7 it is envisaged that when the evacuation system is in full emergency mode the information projected onto the floor of the aisle 34 may comprise directional information such as directional arrows pointing towards an emergency exit or the like. Referring to FIGS. 8a and 8b it is envisaged that when the system is in standby mode the information projected onto the floor of the aisle 34 may comprise information such as seat numbers or advertisements such as information regarding duty free products, flight/train/bus information, or flight/train/bus offers. In a preferred embodiment the projected information may be changed periodically for example every 15-20 seconds.

It will be understood that the shapes of the devices, other components are projections as well as the projected images, shown in the drawings are provided by way of example only. Other shapes and images may be used as desired.

The information projected by the lighting device may comprise route guidance information, advertising or other information, such as information relevant to the particular location of the device, and may comprise still or moving images. The images may comprise colour images.

The present invention is not limited to the embodiments described herein, which may be amended or modified without departing from the scope of the present invention.

1. A lighting device for a route guidance system, said lighting device comprising a body adapted to be mounted to a surface; at least one light source housed within the body; a corresponding at least one outlet in the body from which light may be emitted; and focusing means operable to focus the light into a beam projecting from the outlet.

2. A device as claimed in claim 1, wherein the light source comprises at least one of at least one LED, a laser cluster or any other suitable light source.

3. A device as claimed in claim 2, wherein the light source comprises an array of LEDs.

4. A device as claimed in any preceding claim comprising a pair of outlets in the body, the focusing means being operable to focus light from the at least one light source into a pair of beams, one beam projecting from each outlet.

5. A device as claimed in claim 4, wherein the pair of outlets are arranged such that the pair of beams are directed in substantially opposite directions to one another.

6. A device as claimed in any preceding claim, wherein the focusing means is operable to focus the beam onto, in use, a surface adjacent the device.

7. A device as claimed in claim 6 adapted to project static and/or moving images onto an adjacent surface.

8. A device as claimed in claim 7 adapted to project directional information, such as a directional arrow, onto said surface and/or to project advertising images onto said surface.

9. A device as claimed in any preceding claim actuable in response to a signal from at least one sensor.

10. A device as claimed in claim 9, wherein the sensor comprises one or more of a heat sensor and/or a smoke sensor and/or an auditory sensor and/or a light sensor operable to generate a signal on detection of a reduced light level.

11. A device as claimed in any preceding claim further comprising an independent power supply.

12. A device as claimed in any preceding claim is arranged to communicate with a remote device or one or more other similar or identical lighting devices.

13. A device as claimed in claim 12 arranged to receive and send information to the remote device or one or more other lighting devices

14. A device as claimed in any preceding claim, arranged to project one or more of still images, moving images and/or an image stream.

15. A device as claimed in any preceding claim, wherein the device includes a motion and/or location detector and is arranged to communicate movement and/or location information to a central controller.

16. A device as claimed in any preceding claim, wherein the device comprises an auditory emitter operable to emit an auditory signal.

17. A device as claimed in any preceding claim, wherein the device is adapted to be integrated into an existing alarm system.

18. A device as claimed in any preceding claim, further comprising a counter operable to count the number of people passing the device.

19. A route guidance system comprising a plurality of lighting devices in accordance with any preceding claim.

20. A system as claimed claim 19, wherein a plurality of said devices are arranged, in use, in series such that the facing beams of adjacent devices converge.

21. A vehicle having a route guidance system incorporating at least lighting device according to any of claims 1 to 18.

22. A vehicle as claimed in claim 21, wherein said lighting devices are incorporated into seats within the vehicle.
